(19) United States
(12) Patent Application Publication
(10) Pub. No.: US 2015/0189705 A1
(43) Pub. Date: Jul. 2, 2015

(54) DEVICE FOR GENERATING ELECTRICITY BY HARNESSING SOLAR ENERGY AND METHOD THEREOF

(71) Applicant: Rohit GHOST, West Bengal (IN)

(72) Inventor: Rohit Neil Ghosh, West Bengal (IN)

(21) Appl. No.: 14/419,812

(22) PCT Filed: Sep. 25, 2012
(86) PCT No.: PCT/IN2012/000636

§ 371 Date: Feb. 5, 2015

(30) Foreign Application Priority Data
Aug. 8, 2012 (IN) 895/KOL/2012

(51) Int. Cl. H05B 33/08

(52) U.S. Cl. CPC H05B 33/0803

(57) ABSTRACT

The present invention relates to a device for continuous indoor/outdoor illumination of directly from Solar Panel using native DC current to drive LED Lights (Luminaire), an Auto Grid Control and PV Panel Switcher array of two Relay Switches wherein one of the Relay Switches is co-located with the Solar Panels for toggling on/off solar input in case of periodic or intermittent low solar insulation below an acceptable adjustable threshold, which in turn triggers the 2nd Relay Switch co-located with the set of Luminaire to seamlessly switch over to the grid or solar, thus catering for inadequacy or erratic solar insolation.

The present invention relates to a device which enables complete indoor lighting directly from Solar Panel into native DC LED lights controlled through two relay switches, of which one is co-located with the Solar Panels that switches-off solar input the moment outdoor ambient insolation reduces below an user set threshold thereby triggering the 2nd Automated Relay Switch near the set of luminaire to switch over to grid and vice versa, through a low cost novel innovation that seamlessly overcomes weak insolation in the morning and evenings as also erratic solar insolation due to random cloud shadows.

### FIELD OF THE INVENTION

This innovation is in the field of optimally harnessing Solar Energy. About 970 trillion kWh of energy reaches the Earth every day. Almost all offices the World over function between 9 AM to 6 PM, it is surprising that almost all of them use electric grid lighting for illumination of their work spaces. It is therefore alarming that while outside a bright sun rains free energy the same is hardly utilized indoors.

### OBJECT OF THE INVENTION

The object of the present invention is to provide a means for direct utilization of solar power to illuminate and aerate indoor spaces at a low deferred cost initially and free thereafter.

### BACKGROUND OF THE INVENTION

Solar Energy has been harnessed through various methods, both actively and passively for ages. Photovoltaic, concentrators and evacuated tube methods have evolved considerably. Sunlight has been piped through fibre optics and delivered indoors passively. Tracking mechanism has optimized sunlight collectors' absorption capabilities. Integration of batteries has increased comfort by seamless uninterrupted power supply to meet the power demand of its clientele.

Until the year 2010, against a potential of nearly 20-30 MW per Sq km from solar energy across most of India, dismally, only 10.3 MW Grid Interactive power has been harnessed across India. This however was a quantum jump; an almost five fold rise in installation in 2009 and 2010 showing a phenomenal growth prospects in this segment as an idea of the shape of things to come.

If an office which is grid illuminated during the day adopts the device of the present invention, it would need to pay a recurring expenditure roughly equivalent to its electric bill for about 8 to 10 years and then enjoy free power for the next 10 years without any further expenditure on lighting and fan.

Following are a few instances of existing art known in the public domain which partially relate to the subject matter of the present invention:

U.S. Pat. No. 4,021,267 discloses an apparatus which permits the use of a large proportion of the solar spectrum in the conversion of solar energy to electricity by means of photovoltaic cells. The apparatus comprises a collecting element which concentrates the incident radiation, a collimating element which forms the concentrated incident radiation into a beam of parallel photons, a spectral separation element, such as a prism, prism plate or diffraction grating which spectrally separates the solar radiation in the collimated beam and a plurality of photovoltaic cells disposed in the separated spectrum, the energy gap of the cells being matched to the energy of the photons in that portion of the spectrum in which the cells are located. But it doesn't overcome the drawback of constant illumination even in case of low insolation.

U.S. Pat. No. 4,191,901 discloses a method and a system for converting solar energy into electricity by means of a magneto hydrodynamic (MHD) generator. The method comprises providing an organic liquid reservoir having an ejector nozzle positioned at the inlet port of a MHD generator, providing a liquid alloy reservoir in fluid communication with said inlet port, and heating said organic liquid to its boiling temperature by means of solar energy absorbers so as to form high pressure vapors of the organic liquid adapted to propel the liquid alloy through said MHD-generator, whereby solar heat energy is converted into mechanical energy and said mechanical energy is converted into electrical energy in said generator. The system comprises an organic liquid reservoir having an ejector nozzle positioned at the inlet port of said MHD-generator, a liquid alloy reservoir in fluid communication with said inlet port, a solar energy absorber adapted to heat said organic liquid to a boiling temperature to form. It does not involve the use of any of the invented devices of the present invention and relates mainly to the process of generation of electricity and does not remotely relate to the constant illumination process of the present invention.

U.S. Pat. No. 6,686,533 discloses an energy converting system including a cell array and a light concentrating unit directing concentrated light at the cell array, the cell array including a plurality of cells, wherein the cells are coupled together according to the flux of the concentrated light which reaches each of the cells.

U.S. Pat. No. 4,942,736 provides a method of and apparatus for producing power from solar energy wherein a solar collector heats gas supplied to a gas turbine; compressors compress the gas, the gas being compressed and stored gas during a first period of time, with the stored compressed gas being supplied to the gas turbine during a second period of time to produce power by driving an electric generator. Preferably, the first period of time is during periods of off-peak electricity, which normally occur at night. The second period of time is during the day. The solar collector preferably comprises tracking reflectors for focusing solar radiation and a receiver for receiving the focused solar radiation and also heating the gas. The solar radiation receiver preferably comprises a rotating ceramic member. Furthermore, a combustion chamber is preferably provided to heat the gas entering the gas turbine and is operated by a temperature sensing/control unit when the solar radiation received.

U.S. Pat. No. 4,260,220 provides for piping of outdoor light directly into indoors through fibre optics and related optical methods. While this system is useful with corrective redundancy to avoid ill-effects of lower insolation. Light pipes using hollow tubes with various highly reflective inner surfaces are used to guide sunlight or artificial light over short distances for lighting purposes inside buildings. Particular efficient methods is described in this patent “Prism light guide having surfaces which are in octature” issued to Lorne A. Whitehead on Apr. 7, 1981.

U.S. Pat. No. 4,895,420 provides for another method used for lighting described in “High Reflectance Light Guide”, issued to John F Waymouth on Jan. 23, 1990.

Light pipes are characterized by their aperture, acceptance angle and attenuation. While light pipes are effective and a passive system for indoor illumination indoors, in thick cloud cover it is unable to generate requisite light indoors. Further, at night the fibre optic cable system is ineffective on providing uninterrupted lights indoors through the same luminaries.

US Patent Application US2010/0269817 A1 provides for another related method of concentrating solar energy in the high earth atmosphere for transmitting concentrated solar energy to the Earth's surface more fully described in applied by Edmund Kelly on Oct. 28, 2010. While this invention by virtue of being high in atmosphere may provide 24 hour solar power, cost implications are considerably high in comparison to the instant application.

The most popular and related method is using photo voltaic panels for providing lighting indoors through an inverter driven by a battery which is charged by Solar energy, and this is almost omnipresent in our lives today, quite unlike the current innovation which provides direct illumination driven by uninterrupted grid tied, native DC power from Photo Voltaic Panels.

Another method in vogue across the World is the utilization of a Light Sensor for switching over from a state of “Off” to “On” in street lights which may be using a solar PV for charging a battery during the day and discharging during the night. As on date, light sensitive sensors (or light detecting resistors) do not provide sensitivity to determine the intensity of light at 9 AM or 3 PM and 4 PM and operate only when ambient conditions are dark, such as dusk or dawn so as to switch on/off street lights, unlike the present invention through innovation in application which provides for more sensitive intensity evaluation in bright sunlight and discern intermittent shadows.

Yet another non related Prior Art is the innovative use of fenestrations/sky lights to passively direct outdoor lights indoor. These could be sky lights and windows to provide light indoors, but rarely are these very effective in providing uniform lighting indoors for office applications.

None of the Solar Solutions on date have a direct photovoltaic based delivery of illumination into indoor spaces by drawing on the power of the bright sun outdoors.

All the background arts are only a gateway to one of the embodiments of the present invention and leave ample scope for further development which has been represented in the present invention.

### SUMMARY OF INVENTION

The device of the present invention enables complete indoor/outdoor lighting from Solar Panel directly. LED lights have been used since they natively work on DC. This low cost novelty prototype assembled for enabling the invention employs two 300 milliamp 12V relay switches in an innovative arrangement that triggers automatically based on ambient light conditions. One of the relay switches is co-located with the Solar Panels which switches-off solar input the moment insolation reduces below acceptable adjustable threshold. This in turn triggers the 2nd Relay near the set of luminaire to seamlessly switch over to grid, thus catering for inadequacy in erratic solar insulation due to random cloud cover or weak insolation in the morning and evenings. A weak (sized) solar panel has been used to act as a sensor to determine illumination intensity since regular light sensors (LDRs) do not have the required bandwidth to differentiate changes in light pattern in bright light conditions. As an expansion to this innovation, LDRs may be harnessed to achieve the same switching ability using optical methods.

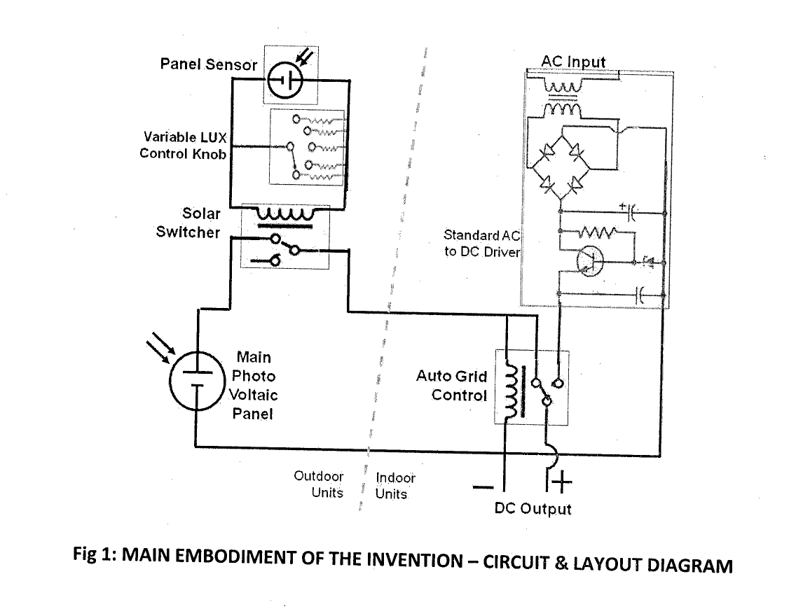

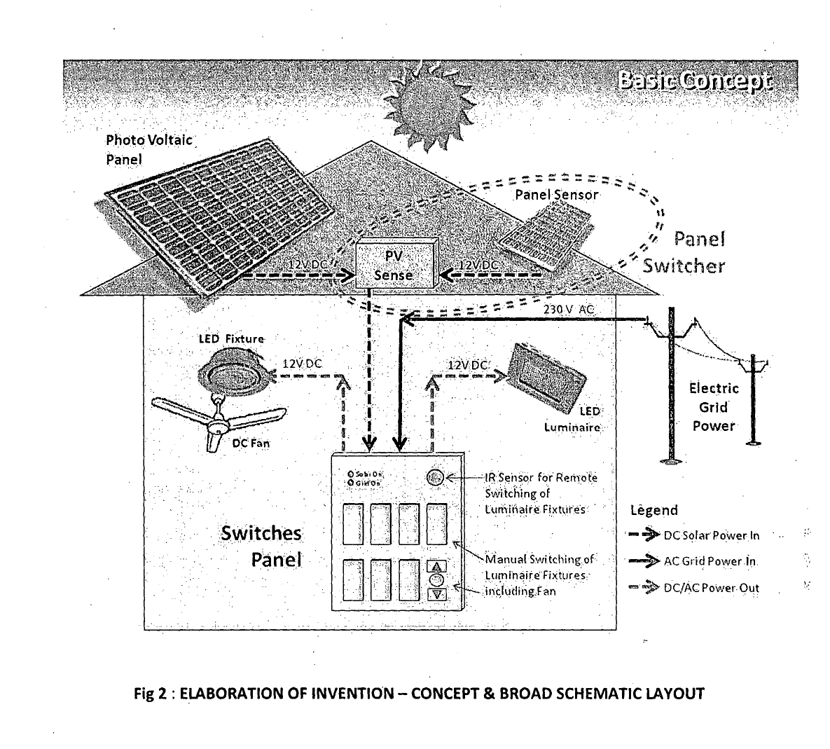

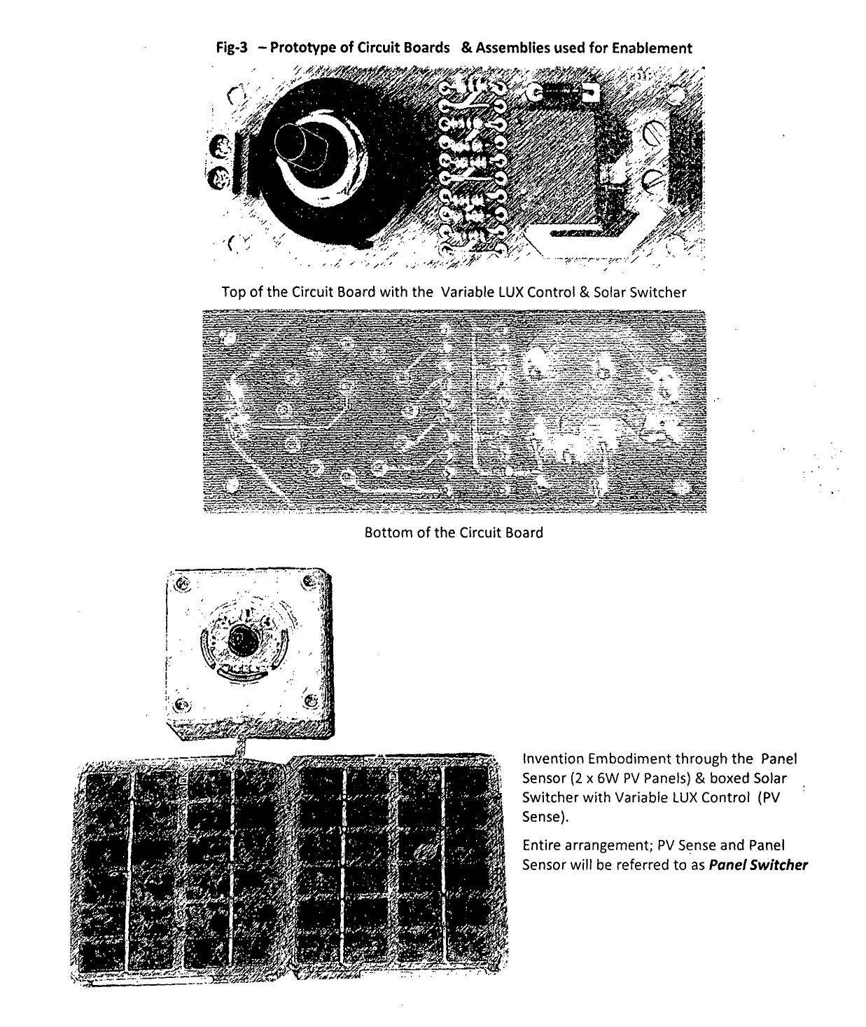

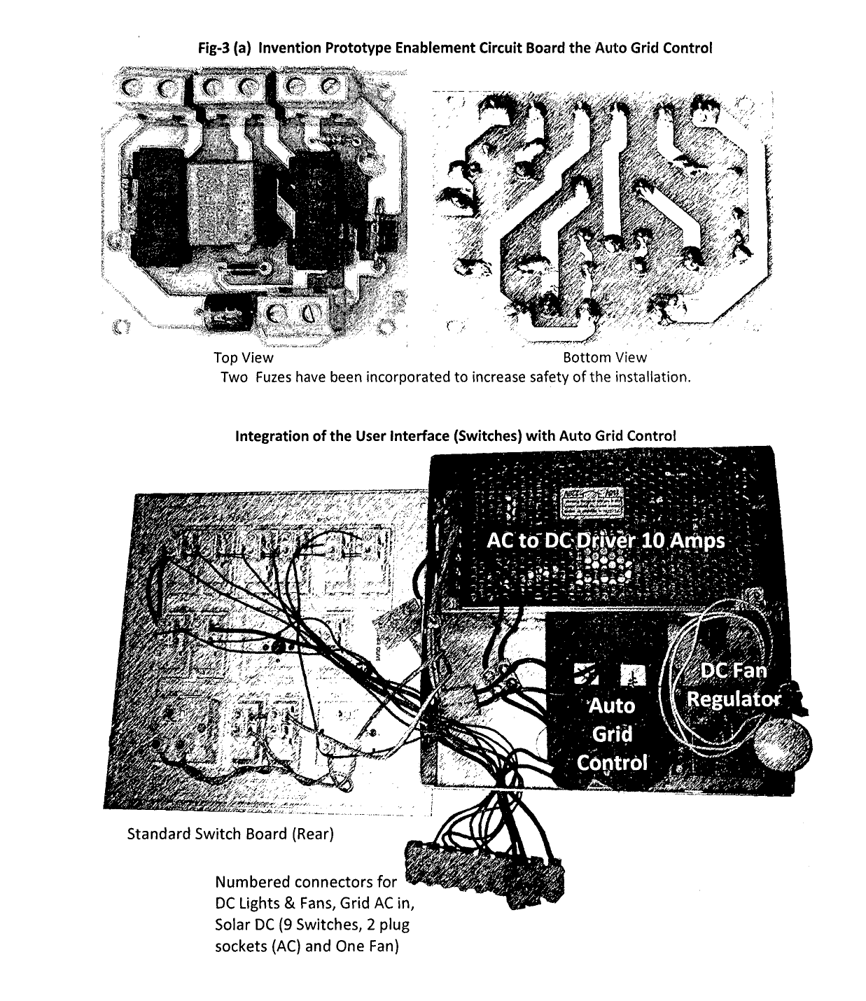

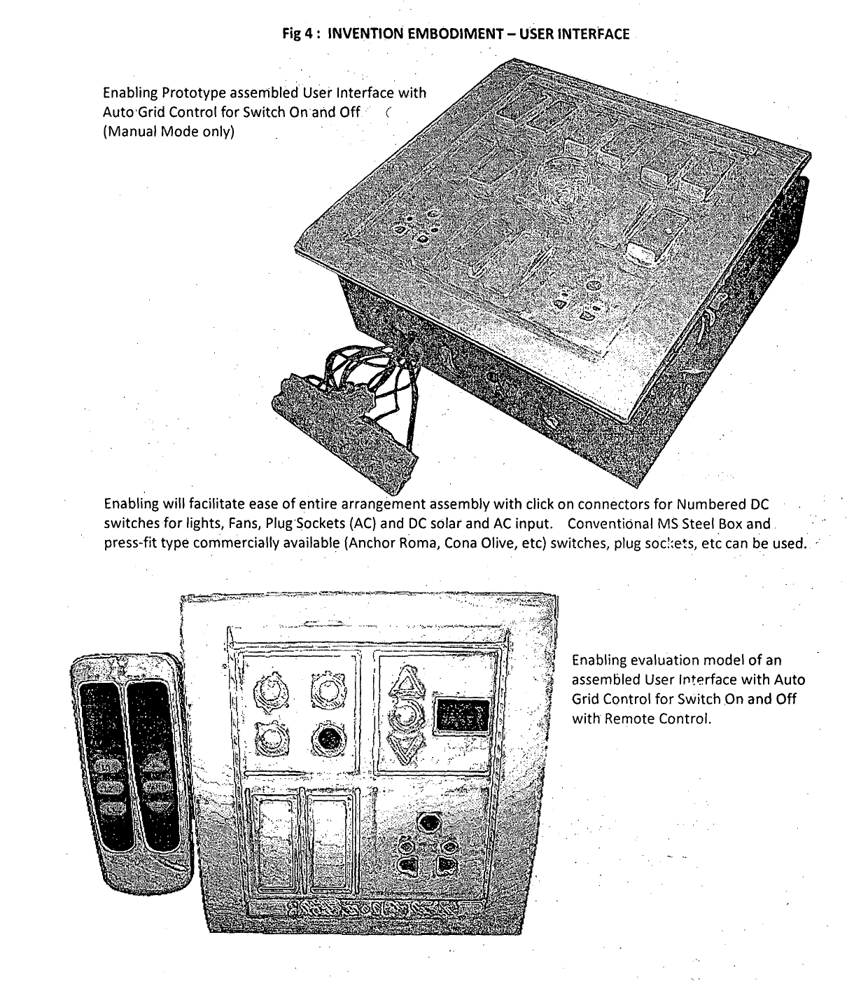

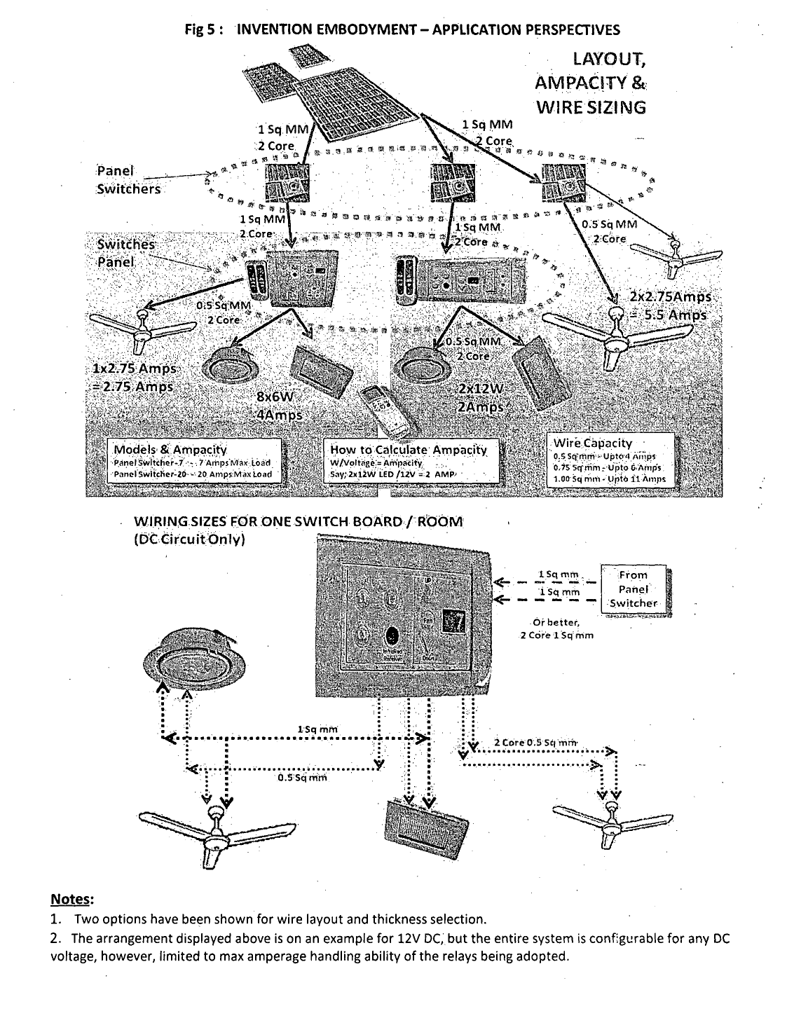

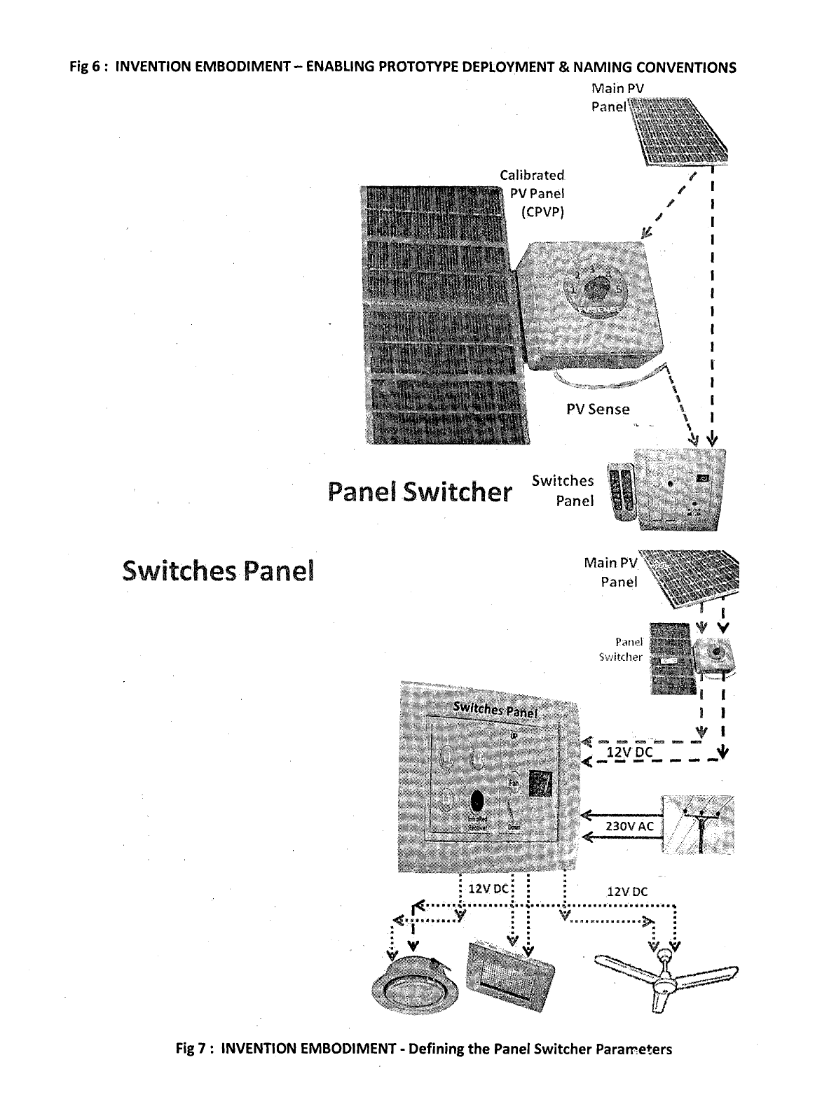

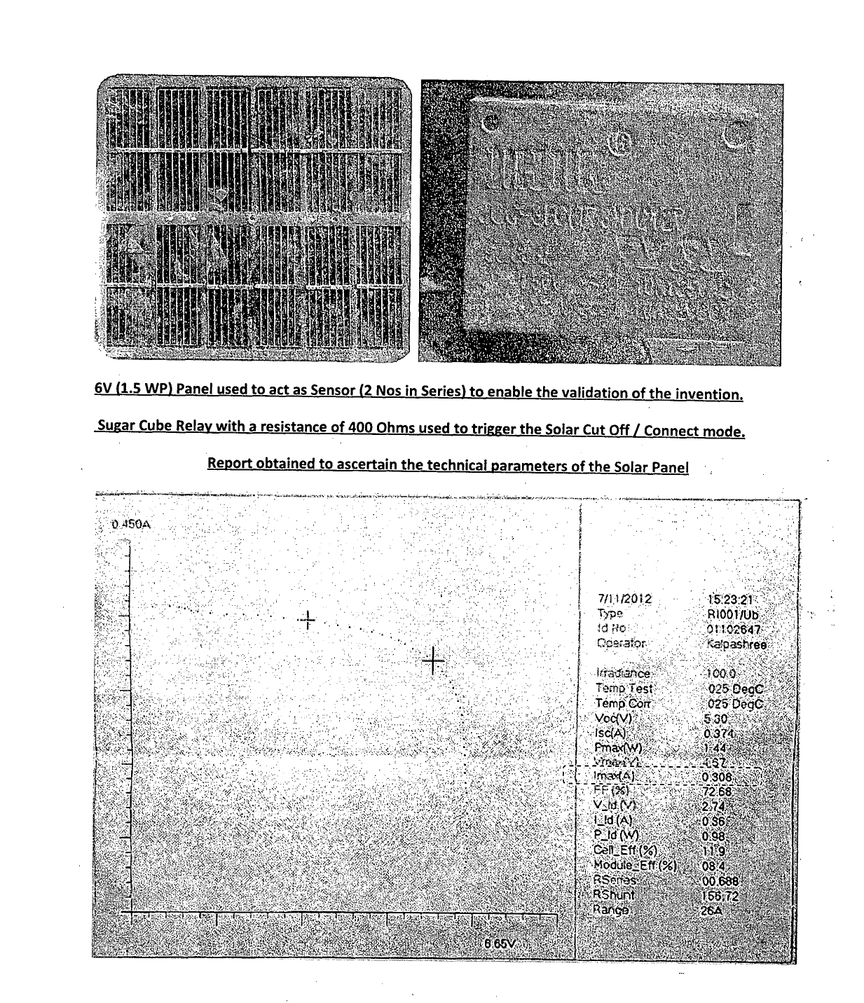

### DESCRIPTION OF DRAWINGS

| FIG. Reference | Description |
|---|---|
| FIG. 1: Main Embodiment of | Circuitry and flow diagram to indicate |
| the Invention - Circuits & | (a) Panel Sensor (Sized PV Panel). |
| Layout Assembly | (b) Solar Switcher with Variable LUX Controller. |
| | (c) Auto Grid Controller. |
| | (d) Integration (Assembly) Auto Grid Control & AC to DC Driver. |
| | (e) Descriptive Notes of connectivity & naming conventions. |
| | Notes |
| | Above arrangement shows the connection of two relays when |
| | Solar Insolation is adequate. |
| | In this, the Panel Sensor is receiving adequate illumination and |
| | able to deliver requisite power to keep the Solar Switcher (Relay's |
| | NO, ie., Normally OFF) connection active. |
| | Since the Auto Grid Control Relay is receiving power from the |
| | Main Photo Voltaic Panel, it is also keeping the NO connection |
| | active. This way, the Luminaire/Fan is directly being powered |
| | from the Solar Panel in its native DC source. |
| | Auto Switch Over The moment Solar Insolation reduces due to |
| | random cloud cover or in the morning or evening, the Panel |
| | Sensor output will diminish. At a predetermined threshold, the |
| | power supplied by the Panel Sensor will fall below the ability of |
| | the Solar Switcher Relay which needs a minimum current to keep |
| | the Switch in NO position. Once this threshold is reached, the |
| | Relay will drop the NO connection and get connected to its NC |
| | (Normally Connected) route, thereby disconecting power downline |
| | to the Auto Grid Control. |
| | The moment Auto Grid Control Relay stops receiving power from |
| | the Main Photo Voltaic Panel,it drops its NO connection and |
| | reverts to its NC route, thus seamlessly switching over to Grid |
| | Power (inverted to DC) for powering the Luminaire/fan Circuit |
| | The arrangement of the Panel Sensor, Variable LUX Control & |
| | Solar Switcher is to be called the Panel Switcher. The arrangement |
| | of the Auto Grid Control along with the AC to DC Driver wired to |
| | the User Interface (switches and remote control) will be called the |
| | Switcher Panel. |
| FIG. 2: Schematic Layout | Basic Concept of the Invention and overall layout |
| FIG. 3/3a: Prototype | Electronic assemblies for Prototype enablement of the invention |
| Assemblies | (a) Circuit Board for Variable LUX Control & Relay |
| | (b) PV Sense & Panel Sensor integration (Panel Switcher) |
| | (c) Circuit Board for Auto Grid Control |
| | (d) Integration of User Interface (Innards) |
| FIG. 4: Invention User Interface | User Interface for Prototype enablement of the Invention |
| | (a) Regular Switch Board |
| | (b) Remote Control based Switch Board |
| FIG. 5: Invention Deployment - | Enablement Overview and Wire Sizing |
| Application Perspectives | (a) Multiple Room / Area Deployment from same Solar Bank |
| | (b) How to calculate Ampacity & Wire thickness. |
| | (c) Single Room wiring pattern (two options) |
| FIG. 6: Enabling Prototype and | (a) Panel Switcher |
| naming conventions | Description: The panel switcher comprises of a Calibrated Photo |
| | Voltaic Panel (CPVP) and the PV Sense. The CPVP senses the |
| | luminosity (solar insolation) and passes the signal to the PV sense. |
| | The CPVP may be an independent unit or may come integrated |
| | with a master PV panel supplied by any Solar Panel Manufacturer |
| | as a special PV Panel. |
| | The PV Sense is an all weather proof box with control knob for |
| | adjusting the required luminosity based on user preference. While |
| | deploying, it should be protected from direct sun and rain by |
| | locating it behind the CPVP. |
| | How to connect: The Panel Switcher is basically a switch that |
| | interposes between the main Solar Panel bank and the point of |
| | use. |
| | To connect, the positive output from the main PV Panel is |
| | connected to the Switches Panel. |
| | The ampacity of the device is in between 7-20 amps. |
| | (b) Switches Panel |
| | Description: Switches Panel has a controller which constantly |
| | monitors the input from the Solar Panel through the Panel |
| | Switcher. As soon as the Panel Switcher disconnects the solar |
| | power input, the switches panel sensor automatically switches the |
| | load to the Grid Power thereby providing uninterrupted lighting. |
| | How to connect: The switches panel is to be connected like a |
| | regular electrical switch board with minor changes. The thickness |
| | of the wires are required to be based on ampacity pattern. |
| | To connect, the output from the Panel Switcher is fed into the |
| | Switches Panel in the slot provided. Similarly Grid Power is fed |
| | into the appropriate slot. The output from the Switches Panel is |
| | fed to the LEDs and fans as per serial number given in the out |
| | pattern. A flow of connectivity pattern is given in the schematic |
| | diagram. |
| | The heart of the basic model of the above device consists of an |
| | automatic switcher from solar to grid based on an input from the |
| | panel switcher. In addition, an AC to DC driver (of an appropriate |
| | ampacity) is required to be connected to the circuit. |
| | Two R1 to R8 remote switching models are required to channelize |
| | into multiple switches with encapsulated AC to DC drivers. |
| FIG. 7: Enabling Prototype - | (a) 6W Panel |
| Defining the Panel Switcher | (b) Panel Test Report |
| parameters | (c) Sugar Cube Relay Switch |

### DESCRIPTION OF THE INVENTION

The values of resistance, current, voltage, luminous intensity and power given here are an example to describe this invention. These values may be changed to adapt to various power load situations and therefore the specific values given in this application are to be taken as an instant example.

Nature of Solar Radiation & Requirement of Illumination: Since Solar irradiation is inadequate in the morning and evening, output from the Photovoltaic Panels (PV) if directly connected to any Luminaire will cause them to dim in intensity during these times when the inclination of the Sun is closer to the horizon as also on cloudy days.

The desired illumination intensity will vary from the end user work functionality requirements. For example an office will have different need from a factory work floor. An assembly line in a factory where detailed work is done manually, say an electronics assembly bench will require more illumination than a car body assembly line.

As per standard illumination norms, it is almost universally accepted that about 500 LUX upwards is adequate for office work, where 1500 LUX would be required for more deliberate work. Passages and common areas need just about 100 to 200 LUX for its purpose. The illumination pattern achieved will depend on the wattage of luminaire being used as also its distance (height from work table) and overlap of neighbouring luminaire from the work space; and all these naturally, will vary from location to location.

Also, the intensity of solar illumination varies at each latitude, reducing progressively as one move towards the poles, as also, at any specific point of time in a day, considerable light intensity variance occurs during winter and summer. For example, at Bangalore latitude in summer, at about 4:30 PM when offices are open and functional, about 4000 LUX is obtained on a solar panel outside but this does not fully deliver the required current to LED Luminaire indoors if directly connected to a solar panel. This would cause dimming of directly connected LED luminaire indoors which may not be acceptable for some users. The same lighting condition would probably occur at 3:45 PM in winter. Therefore a configurable arrangement would make this transition seamless indoors immaterial of the time of the year.

Therefore, a configurable Solar to Grid and vice versa switchover has been designed so that users can define the cut off point based on ambient illumination native to their location/requirement and set the same at the PV Panel itself.

In this invention, while Power for illumination (and other loads which can run on Solar power) is drawn from a standard Solar Photo Voltaic Panel which is sized conventionally, i.e., based on its dependent load pattern, another subsidiary panel has been added to act as the sensor and trigger. Power from the main Solar Panel is directly sent in DC Mode through conventional cables to the Luminaire indoors.

Photovoltaic Sensor & Control: To automatically Switch Off the solar power when insolation is low or unacceptable, an innovation of using a weak (sized) PV panel is used as the light sensor. This has been adopted since conventional Light Sensors (also known as LDRs or Light Detector Resistors) commonly available has a tolerance of about 1000 LUX which is not adequate to perform the task of sensing illumination variations beyond this limit. After trials, it has been estimated that the required outdoor unit switch OFF is required when illumination levels are in the range of 4000 LUX (as read on a Blackberry Engineering OS LUX Sensor). Details and method of this panel sizing is given at FIG. 7.

This weak sized panel (hereinafter referred to as Panel Sensor) has been connected to the Luminaire Load through a 12V 60 milliamps Relay (Solar Switcher). This is used to Switch ON/OFF the Solar input to the Auto Grid Control.

The output of the main solar panel is interrupted by the Solar Switcher, in which the Relay's NO (Normally Off) is connected since it receives power from the Solar Panel (Panel Sensor). Whenever the current drops due to weak solar insolation, it cannot hold on to the NO and therefore drops the connection, reverting to its NC (Normally Connected) position, thereby disconnecting the weak solar power (current) going to the Solar-Grid-Tie-Up (Auto Grid Control). It may be noted that during this phase the Voltage remains constant within a narrow bandwidth. Refer FIG. 1 for details. The entire set components in this prototype enablement arrangement (hereinafter referred to as Panel Switcher) are as given below:
(a) Solar Panel to be used as Sensor −12V delivering 300 milliamps.
(b) Sugar Cube 12V consuming 60 milliamps.
(c) Balancing Resistors in Parallel 220 milliamps.
(d) Remnant 20 milliamps as scope for dimming allowed by user.

In this specific, arrangement, the moment solar insolation reduces, the panel's ability to deliver amperage drops and since the same crosses the threshold point of the Relay's hold on to NO, it trips and reverts to NC position which in effect disconnects the solar output to the Solar-to-Grid-Tie-up.

To cater for multiple user requirements/illumination specification, a pot with variable resistance upwards of 44 Ohms upto 60 Ohms has been introduced by means of a pre-set rotating switch to allow the user configure the cut off threshold and perhaps harness more solar energy albeit with a lesser illumination or define the acceptable illumination by cutting off the solar energy appropriately. This has been achieved by enabling options with variable resistance loads as follows:—
(a) 47 Ohms (enables switch off of Solar at around 4000 LUX).
(b) 52 Ohms (enable user select switch off with lesser LUX input).
(c) 60 Ohms.
(d) 66 Ohms.

Solar to Grid Tie-up Sensor & Control (Auto Grid Control): The DC power line from the Photo Voltaic Panels which is regulated through Panel Switcher as described above is connected to the 2nd 12V 60 mA relay. The positive terminal of the solar input is connected to the NO of the relay while the positive of the Electric Grid supply is connected to the NC. The COM acts as the common positive terminal for the whole device. The negatives from both the solar input and grid supply are connected together and act as the negative terminal for the device.

As soon as the Solar Input is disconnected by the Panel Switcher, this Relay (Auto Grid Control) drops the NO thus returning to its normal state and the Grid connected NC gets activated. This enables a seamless switchover to grid power and vice versa.

Luminaire & Fan Control: The Auto Grid Control is required to be placed indoors. Also, since LEDs are being driven by DC which is native to the Main Solar Panel, there is a need to interface an AC to DC Driver of requisite Amperage. Luminaires are required to have DC Constant Current drivers for optimum life of LEDs. Fans may be put on a separate circuit since they do not need as much sensitivity. They could be wired to another PV Sense with a setting that allows longer hours during day from Solar as well as eliminating the switch on/off routine during intermittent cloud cover.

For optimal power supply, FIGS. 5 and 6 indicate wire thickness and ampacity guidelines in wiring diagrams. All arrangements allow for ‘Remote switching’ of luminaire and fans.

In all cases, requisite fuses are included to ensure safety of the entire installation since DC does not have an earth line.

Uninterrupted Power Supply: The arrangement above has been configured to avoid the use of batteries which have a much lesser operational life to cut down costs of battery replacement every 2 to 4 years. However, where grid power is not stable, and to eliminate outages from affecting indoor operational performance, a UPS may be employed to keep grid power seamless. The batteries should in such a case be charged by Solar Power and therefore the “Main PV panels” would need to be sized appropriately.

The above arrangement may be enhanced by utilizing the excess power available when the PV Sense has switched to Auto Grid Control. This would happen early mornings and late evenings or during random/constant cloud cover. An arrangement to deliver power from the NO of the PV Sense to the battery can be made. However battery sizing will need to be reconsidered.

Wind Turbine and Direct DC Supply from Battery Integration: A wind turbine as well as a direct DC supply from a battery can be seamlessly integrated into the system by using a programmed logic for power supply. However the same is not described any further since it is out of the scope of this invention.

Determining Threshold Voltages: Working parameters are given at FIG. 7.
Imax of the 6 W panel is (approx) 300 mA.
Voltage provided by panel is 12V (approx), ie., 2×6V in Series.
Using R=V/I, we can determine that Resistance that consumes 300 mA entirely is given by V=12V, I=300 mA=0.3 A
Hence R=12/0.3 ohm=40 ohm.
Resistance offered by relay is (approx) 400 Ohm.
To get a final resistance of (approx) 40 ohm, a resistance value has to be connected in parallel to the relay.
Combination of resistors in parallel is given by 1/Rp=1/R1+1/R2.
Here Rp required is 40 ohm and R1=400 ohm
Hence from formula, 1/40=1/400+1/R2.
1/R2=1/40−1/400
R2=44.445 ohm.
This is the lowest possible value, values below which will cause the triggering of the relay to fail.
Note: Since Ohms law and formulas for calculating combinations of resistors are abstractions and approximately based on complex and practically unusable equations, these values are not EXACT. Hence some room for error is a prerequisite. Also since exact values such as 44.4 ohms are not available as resistors, the next closest values are used.
However, the equations do show the maximum limitations of the equipment used using which a range can be provided.

### Enablement/Best Method

To enable the invention, the enabler will be required to assemble the kit/circuit as described above and depicted in FIG. 7.

The best method to observe the performance will be to operate the equipment in the afternoon. Once the solar panels are connected, the Solar indicator LED will glow Red. This will indicate that the Solar Panel is generating adequate current to drive the Luminary. To test the system for seamless switch over to grid, the enabler can introduce a shadow over the Sensor Panel by holding any paper/cloth to block the sun rays. It will be seen that the Solar indicator LED will switch off.

If there is intermittent cloud cover, the system will self test itself and the enabler will be able to see the switching happen automatically.

At about 4:30 PM, depending upon the latitude and intensity of the Sun, the Panel Switch will power off and the grid power will take on automatically. Next day, at about 9:30 AM, depending upon the intensity of the sun, the Panel Switch will activate and the enabler will be able to see that the Grid Switch will deactivate. As stated earlier, the Panel Switch will show that the Solar Indicator LED has switched on and glow Red.

From the above disclosure the object of the invention stated herein has been completely fulfilled. Having now fully described this invention, it will be understood by those of ordinary skill in the art that the same can be performed within a wide and equivalent range of conditions, formulations and other parameters without affecting the scope of the invention or any embodiment thereof which is governed by the claims followed hereafter.

1. A device for continuous illumination for complete indoor/outdoor lighting directly from Solar Panel consisting of DC current driven LED Lights, a set of Luminaire, a Grid with Auto Control and two 300 milliamp 12V Relay Switches;
wherein one of the Relay Switches is co-located with the Solar Panels for switching off solar input in case of lower solar insulation below an acceptable adjustable threshold resulting in triggering the 2nd Relay Switch co-located with the set of Luminaire to seamlessly switch over to the grid, thus catering for inadequacy in erratic solar insulation.

2. A device for continuous illumination as claimed in claim 1, wherein the solar panel is used as a sensor and is a particular panel built of low power, being connected to a Luminaire Load through a 12V 60 milliamps Relay Switch used to switch off the solar input to the Auto Grid Control to determine illumination pattern to differentiate changes in dim/bright light conditions.

3. A device for continuous illumination as claimed in claims 1 and 2, wherein the input and output modes of the main solar panel are connected to a pair of Relay Switches in Normally Off (NO) mode in case of adequate supply of solar power and in Normally Connected (NC) mode in case of power shortage thereby disconnecting power transmitted to the Auto Grid Control.

4. A device for continuous illumination as claimed in claims 1 to 3, wherein the components in the arrangement of the Auto Grid Control consists of:
Balancing Resistors in Parallel 220 milliamps;
Remnant 20 milliamps as scope for dimming allowed by user;
a pot with variable resistance of 44 Ohms-60 Ohms situated by means of a pre-set rotating switch to allow the user to configure the cut off point and to harness more solar energy albeit with a lesser illumination or define the acceptable illumination by cutting off the solar energy appropriately in order to cater for multiple illumination specifications.

5. A device for continuous illumination as claimed in claims 1 to 3, wherein a DC distribution box is used next to the Auto Grid Control where DC drivers are arranged duly sized for luminaire to be used on standard configuration pattern viz. 3 W down lights NOs to 36 W flat panels batched together.

6. A process for continuous illumination consisting of a Photovoltaic Sensor & Control and a coil, wherein:
the sensor panel provides power to the coil of the relay in the solar sensor;
the excess current provided by the sensor panel is drained by resistors parallel to the coil resulting in the presence of only a minimal amount of current therein;
the relay switches off when the solar irradiation reduces beyond a determinable threshold.

7. A process for continuous illumination as claimed in claim 6 consisting of Solar to Grid Tie-up Sensor & Control wherein:
the positive end of a DC adapter is connected to the Normally Connected (NC) mode and the positive end from the solar panel is connected to the Normally Off (NO) mode of the relay switches;
the negative terminals are connected together with diodes;
a COM acts as the positive terminal for applications.

8. A device for continuous illumination as claimed in claims 1 to 5 substantially as herein described and exemplified.

9. A process for continuous illumination as claimed in claim 6 and 7 substantially as herein described and exemplified.
